(19) United States
(12) Patent Application Publication
(10) Pub. No.: US 2012/0279242 A1
(43) Pub. Date: Nov. 8, 2012

(54) CONTROLLABLE HEAT EXCHANGER FOR A MOTOR VEHICLE AIR CONDITIONING SYSTEM

(75) Inventors: Lothar SEYBOLD, Nauheim (DE); Artem SERYI, Wiesbaden (DE)

(73) Assignee: GM GLOBAL TECHNOLOGY OPERATIONS LLC, Detroit, MI (US)

(21) Appl. No.: 13/462,024

(22) Filed: May 2, 2012

(30) Foreign Application Priority Data
May 6, 2011 (DE) 10 2011 100 706.0

(51) Int. Cl. G05D 23/00; F25D 17/00

(52) U.S. Cl. 62/190; 165/287

(57) ABSTRACT

A heat exchanger for a motor vehicle air conditioning system is provided. The heat exchanger includes an inner tube through which a heat exchanger medium can flow, an outer tube that at least regionally envelops the inner tube forming an intermediate space, and a regulating unit fluidically connected to the intermediate space. The regulating unit is configured to alter the flow resistance of the intermediate space as a function of the temperature of a heat exchanger medium that flows through the intermediate space.

### CROSS-REFERENCE TO RELATED APPLICATIONS

This application claims priority to German Patent Application No. 10 2011 100 706.0, filed May 6, 2011, which is incorporated herein by reference in its entirety.

### TECHNICAL FIELD

The technical field generally relates to a heat exchanger or heat transferring device for a motor vehicle air conditioning system, which is designed in particular to exchange thermal energy inside a refrigerant circuit.

### BACKGROUND

Known in the art for increasing the performance and efficiency of motor vehicle air conditioning systems are air conditioner-internal heat exchangers, so-called internal heat exchangers (IHX). Internal heat exchangers thermally couple a section of the refrigerant circuit running between the evaporator and compressor with a section of the refrigerant circuit running between the capacitor and expansion valve. In this way, the relatively cold refrigerant flowing from the evaporator to the compressor can be used to (pre)cool or supercool the comparatively warm refrigerant supplied to the expansion device on the high-pressure side of the refrigerant circuit.

For example, DE 10 2005 052 972 A1 describes a two-walled heat exchanger tube with an outer tube and inner tube, which define a channel between them. The high-pressure refrigerant here flows through the channel, and the low-pressure refrigerant flows through the inner tube.

The geometric dimensions and shapes of the tubes are of importance for optimizing the function of such heat exchangers in the refrigerant circuit. In an existing vehicle package, which offers no space for individually adapting or changing the outer contour or outer geometry of the heat exchanger, it is comparatively difficult to individually adjust such heat exchangers to prescribed requirements in terms of their heat exchanger capacity, for example specific to the vehicle type.

For example, known heat exchanger configurations described in DE 10 2005 052 972 A1 provide extruded or two-part profile tubes with a heat exchange surface essentially unchanged in the longitudinal direction of the profile. In this regard, they are only able to respectively convey or exchange an always invariable and constant quantity of heat as a function of the length and diameter of the tubes.

In addition, it should be remembered that the refrigerant supplied to the compressor takes up thermal energy in the heat exchanger when using such an air conditioner-internal heat exchanger. In particular, given a comparatively high thermal extraction efficiency of the heat exchanger, the temperature in the compressor can here rise significantly. As a consequence, the heat transfer capacity of such internal heat exchangers should be limited to prevent the compressor from overheating. However, limiting the performance of the internal heat exchanger in this way can sometimes negatively impact the efficiency and effectiveness of the air conditioning system during normal operation.

Therefore, at least one object herein is to provide an internal heat exchanger for a motor vehicle air conditioning system that exhibits the highest possible heat transfer capacity on the one hand, while effectively preventing the compressor of the air conditioning system from overheating on the other. The appropriate measures for this purpose should be as cost-effective and easy to implement as possible. In addition, the long-term operation of the internal heat exchanger is to be as maintenance-free as possible. In addition, other objects, desirable features and characteristics will become apparent from the subsequent summary and detailed description, and the appended claims, taken in conjunction with the accompanying drawings and this background.

### SUMMARY

A heat exchanger is provided as an internal heat exchanger for a motor vehicle air conditioning system. The heat exchanger exhibits an inner tube that can carry a heat exchanger medium, along with an outer tube preferably arranged concentrically thereto. The outer tube envelops the inner tube accompanied by the formation of at least one flow-through intermediate space. The outer tube regionally envelops the inner tube in the longitudinal or axial direction of the tube.

A regulating unit is fluidically connected with the intermediate space through which the heat exchanger medium can flow. The regulating unit is configured to alter the flow resistance of the intermediate space as a function of the temperature of the heat exchanger medium. In this way, the throughput or flow rate of the heat exchanger medium through the intermediate space formed by the inner and outer tube can be specifically changed to adjust or regulate the heat exchange capacity of the heat exchanger.

The heat exchange between a high-pressure and low-pressure side of the air conditioner circuit can be changed if needed, in particular to prevent a temperature increase on the low-pressure side placed upstream from the compressor and an accompanying increase in the compressor temperature within temperature ranges that are least favorable to the way in which the compressor operates. Adapting or regulating the heat exchanger capacity can effectively prevent an overheating that is impermissible for how the compressor operates. This also makes it possible to generally increase the heat exchanger capacity of the internal heat exchanger between the low-pressure and high-pressure sides of the air conditioner circuit, in order to thereby achieve a higher level of efficiency, in particular during the normal operation of the air conditioning system.

In an exemplary embodiment, the regulating unit is situated directly in the intermediate space between the inner and outer tube. In this regard, the regulating unit can be bathed in the heat exchanger medium or exposed thereto in order to measure the temperature of the latter. This eliminates the requirement for a separate measuring device for determining the temperature of the heat exchanger medium. Connecting means between an actuator and sensors for acquiring the temperature of the heat exchanger medium are also advantageously rendered unnecessary.

In a further embodiment, the regulating unit is directly secured to an external side of the inner tube or an internal side of the outer tube. Without needing any external control means, the regulating unit can largely independently make specific changes to the cross section of the intermediate space between the inner and outer tube through which a heat exchanger medium can flow as a function of the temperature of the heat exchanger medium. The regulating unit increases the flow resistance in the intermediate space as temperature rises, and vice versa, reduces the flow resistance of the intermediate space to a minimum as the temperature of the heat exchanger medium drops. In this regard, the regulating unit is designed to diminish the flow cross section of the intermediate space once a prescribed upper temperature limit has been reached so as to reduce the heat exchange capacity of the heat exchanger. As a result, less thermal energy is conveyed from the high-pressure side to the low-pressure side of the air conditioner circuit. This makes it possible to counter an impermissible overheating of the compressor.

In another embodiment, the regulating unit exhibits at least one bimetal segment, which abuts nearly completely against the inner or outer tube at a temperature of the heat exchanger medium below a prescribed threshold. In such a lower temperature range, the bimetal segment or a bimetal strip abuts nearly the entire surface of the inner or outer tube, and thus only slightly impairs the flow-through cross section of the intermediate space. The bimetal segment is configured in such a way as to extend away from the inner or outer tube in a radial direction at a temperature of the heat exchanger medium above a prescribed threshold on the inner and outer tube, so as to reduce a flow-through cross sectional surface of the intermediate space. For example, a bimetal segment arranged on the external side of the inner tube preferably extends radially outward. If the bimetal segment is arranged on the internal side of the outer tube, it preferably extends radially inward once an upper threshold temperature has been reached so as to reduce the flow cross section of the intermediate space formed between the inner and outer tube accordingly.

The regulating unit can further come to abut against an opposing wall section of the inner and outer tube once a closed or end position has been reached, thereby completely closing the intermediate space between the inner and outer tube, at least in partial regions. For example, the bimetal segment arranged on the inner tube can extend up to the internal side of the outer tube. Conversely, it is conceivable for a bimetal segment arranged on the internal side of the outer tube or a corresponding bimetal strip to project radially inward once an upper temperature limit has been reached, and come to abut the opposing wall section of the inner tube.

Another embodiment provides that the intermediate gap formed between the inner and outer tube be divided into several channels in the circumferential direction of the inner or outer tube, which are separated from each other by webs running in an axial or longitudinal direction of the tube. Such webs can be provided on the inner tube so as to protrude radially outward, or on the outer tube so as to project radially inward. The webs can further act as retainer or spacer webs, and are typically formed during an extrusion molding process while manufacturing the inner or outer tube.

The webs running in the longitudinal direction of the tube can also be used to preferably arrange the tubes concentrically relative to each other or concentrically inside each other, thereby yielding several channels running in the longitudinal direction of the tube through which the heat exchanger medium can flow. In this regard, the internal heat exchanger exhibits a coaxial geometry.

The regulating units also can extend over the circumference and/or the cross sectional surface of at least several channels of the intermediate space. It is here advantageous for a single intermediate space channel that at least one respective regulating unit be provided, for example in the form of a bimetal strip or segment.

Viewed in the circumferential direction of the inner or outer tube, a regulating unit provided for an intermediate space channel here extends between two tubular webs situated adjacent to each other in the circumferential direction. The regulating unit adjoins the webs adjacent to the intermediate space channel viewed in the circumferential direction of the tube. In this way, individual intermediate space channels can each be altered by means of one or even several regulating units in terms of their flow resistance, even going so far as to completely block the respective channel.

In another embodiment, several, but not all, channels of the intermediate space have a regulating unit. For example, a regulating unit is arranged only in about 50% to 75% of the channels, so that a flow can at least partially continue to pass through the high-pressure line or tubular intermediate space exposable to the high-pressure heat exchanger medium, even independently of the respective configuration of the tubular heat exchanger.

In a further embodiment, the bimetal segment is aligned or configured opposite the direction in which the heat exchanger medium flows through the intermediate space in terms of its free end section, which can be moved in relation to a nadir. The bimetal segment that can be transferred radially inward or radially outward roughly like a bow or strap into its closed position is in its closed position aligned to face away or opposite the direction of flow with its lower side, which arrives at the inner or outer tube in the open position. In this way, the flow of the heat exchanger medium can support a radially inwardly or radially outwardly directed deformation of the bimetal segment.

However, an upper side of the bimetal segment that faces the flow-through intermediate space in the basic position of the segment may face away from the direction of flow with the bimetal segment in the closed position. In such a configuration, the bimetal segment would also have to work against the flow of the heat exchanger medium while moving into a closed position that at least regionally seals the intermediate space channel.

In another embodiment, individual channels of the intermediate space through which the heat exchanger medium can flow have respectively different regulating units, for example, which exhibit different working points and a correspondingly different temperature sensitivity. For example, one flow channel or a first group of flow channels have a first type of regulating units that diminish the flow cross section of the respective channel already at a comparatively low temperature.

A second flow channel or second group of flow channels can also be equipped with a second type of regulating unit, which only starts to deform so as to diminish the flow cross section of the respective channel in a higher temperature range by comparison to the first type. In this way, a successive and approximately continuous reduction in the flow-through cross sectional area of the tubular intermediate space can be achieved by using differently configured regulating units situated in different channels.

The inner tube of the overall tubular and essentially cylindrical heat exchanger is configured as a low-pressure line, while the outer tube is configured as a high-pressure line in accordance with another embodiment. A heat exchanger medium present in gaseous form here typically flows through the inner tube, while a heat exchanger medium present in predominantly a liquid form and placed under a high pressure flows through the outer tube or the intermediate space formed by the inner and outer tube.

Accordingly, another embodiment provides for arranging the heat exchanger in a refrigerant circuit of an air conditioning system, wherein opposing end sections of the inner tube can be situated downstream from an evaporator and upstream from a compressor, and opposing end sections of the outer tube can be situated upstream from an expansion device and downstream from a capacitor in the refrigerant circuit of a motor vehicle air conditioning system. It here generally holds true that the low-pressure line is configured to fluidically couple the evaporator and compressor, and the high-pressure line is configured to fluidically couple the capacitor and expansion device of the refrigerant circuit of the air conditioning system.

In another embodiment, a motor vehicle air conditioning system exhibits a refrigerant circuit that can carry a flow of heat exchanger medium, which is equipped at least with a compressor, a capacitor, an expansion device and an evaporator, which are serially fluidically connected by means of corresponding lines of the refrigerant circuit, and coupled with each other in terms of fluid mechanics in order to circulate the refrigerant or heat exchanger medium.

The refrigerant circuit here exhibits at least one previously described, preferably tubular heat exchanger, which enables the exchange of thermal energy between the low-pressure side or inlet side lying downstream from the evaporator and high-pressure side of the refrigerant circuit lying upstream from the expansion device.

Finally, in a further embodiment, a motor vehicle exhibits the heat exchanger contemplated herein or an air conditioning system equipped with the heat exchanger contemplated herein.

### BRIEF DESCRIPTION OF THE DRAWINGS

The various embodiments contemplated herein will hereinafter be described in conjunction with the following figures, wherein like numerals denote like elements, and wherein:

FIG. 1 is a longitudinal cross section of a tubular heat exchanger;

FIG. 2 is a magnified view of a regulating unit situated in the intermediate space between the inner tube and outer tube of the tubular heat exchanger of FIG. 1;

FIG. 3 is a cross sectional view along A-A according to FIG. 1; and

FIG. 4 is a diagrammatic view of a motor vehicle air conditioning system with a tubular heat exchanger sketched on FIG. 1.

### DETAILED DESCRIPTION

The following detailed description is merely exemplary in nature and is not intended to limit the the application and uses of the various embodiments contemplated herein. Furthermore, there is no intention to be bound by any theory presented in the preceding background or the following detailed description.

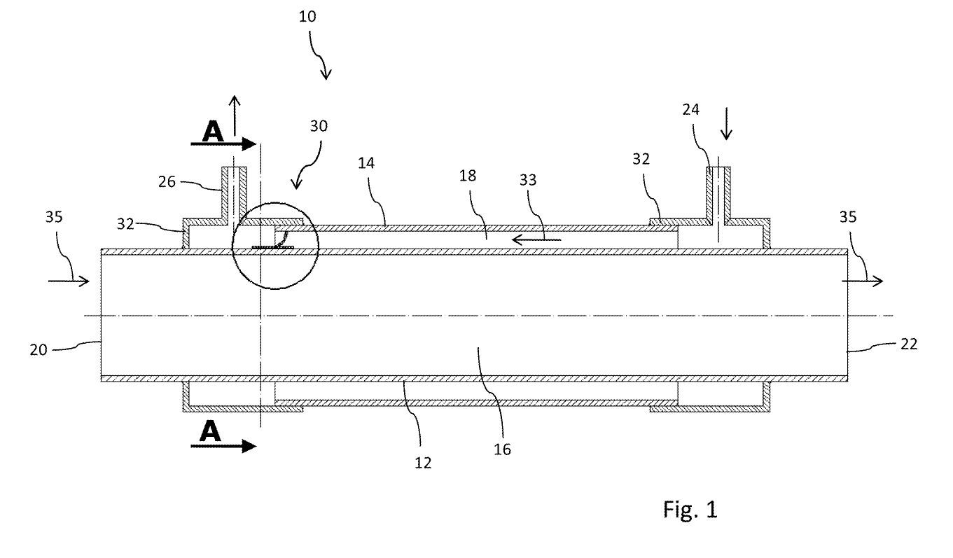

The air conditioner-internal tubular heat exchanger 10 with a controllable heat exchange capacity diagrammatically shown on FIG. 1 exhibits an inner tube 12 as well as an outer tube 14 arranged concentrically hereto. An intermediate space 18 through which a heat exchanger medium can flow is formed between the inner tube 12 and outer tube 14.

As may further be gleaned based on the cross section according to FIG. 3, this intermediate space 18 is divided into individual channels 36, 38, of which at least several channels 36 are equipped with a regulating unit 30. The cross section according to FIG. 3 depicts a total of eight channels 36, 38 each extending in the longitudinal direction of the tube, forming the intermediate space 18 between the inner tube 12 and outer tube 14. Only the four channels 36 lying above on FIG. 3 are here provided with a regulating unit 30, while the lower channels 38 can carry a flow permanently and independent of temperature.

Further shown on FIG. 3 is an external jacket 28 that essentially completely envelops the outer tube, and preferably is used for purposes of thermal insulation.

The regulating units 30 here abut against nearly the entire external side of the inner tube 12 in a basic position. They are preferably designed as bimetal segments or bimetal strips, which in their basic position depicted on FIG. 3 only minimally impede the free flow through the traversable cross section of the respective channels 36.

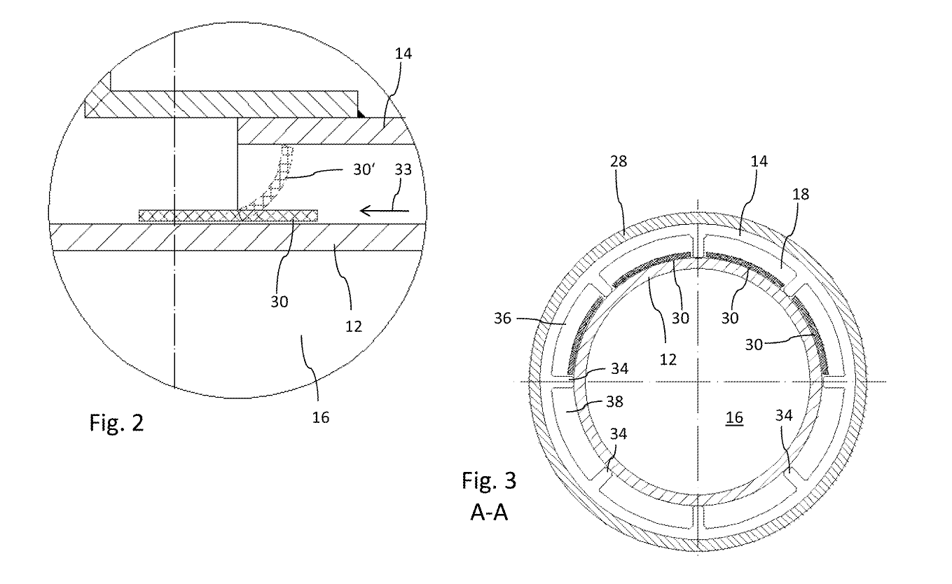

If the temperature of the heat exchanger medium flowing through the intermediate space 18 rises to a prescribed threshold, the regulating units 30 shown in a basic position on FIG. 2 switch to a closed position 30′, wherein a free end section of the respective bimetal segment changes over to a radially outwardly directed configuration 30′, for example until the bimetal segment adjoins the inner wall of the outer tube 14, thereby largely sealing the corresponding flow channel 36.

The configuration shown in FIG. 3 with a total of eight flow channels 36, 38 separated from each other by individual spacer webs 34 can vary depending on the provided heat exchanger design. It is basically also conceivable that the regulating units 30 only be designed to change the flow resistance of the intermediate space 18 in such a way as to seal a corresponding channel 36 only regionally, but not completely, once an end position has been reached.

For example, it is conceivable for the regulating units 30′ in their closed position not to extend over the entire intermediate space between two adjacent webs 34, but rather exhibit a somewhat shorter design viewed in the circumferential direction of the tube, so that only a partial region of the respective channel 36 is fluidically sealed even when a closed position 30′ of the kind sketched on FIG. 2 has been reached.

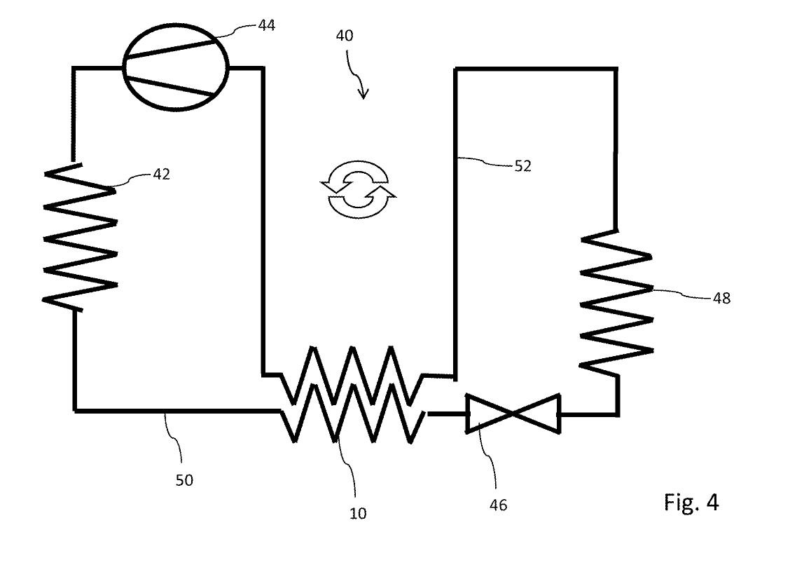

In any event, the intermediate space 18 between the inner tube 12 and outer tube 14 should remain freely traversable up to at least a certain minimum throughput, so that the air conditioning system 40 diagrammatically sketched on FIG. 4 stays operational even independently of the respective configuration of the heat exchanger 10.

FIG. 1 further denotes mutually opposing directions of flow 33, 35 through the interior 16 of the inner tube 12, as well as through the intermediate space 18. It is here provided in particular that an inlet 24 of the outer tube 14 be situated downstream from the standpoint of fluid mechanics in relation to the capacitor 42 of the air conditioning system 40 sketched on FIG. 4, and that an outlet 26 of the outer tube 14 be fluidically connected with the inlet side of the expansion device 46. Accordingly, the outer tube 14 with its inlets and outlets 24, 26 is integrated into the high-pressure line 50 between the capacitor 42 and expansion device 46 of the air conditioning system 40.

As further depicted on FIG. 1, the inlets and outlets 24, 26 for the outer tube 14 are each incorporated in connection nozzles 32, which empty into the cylindrical section of the outer tube 14 on the one hand, and are interspersed by the inner tube 12 in an axial or longitudinal direction of the tube on the other.

In a corresponding manner, the inner tube 12 is integrated into the low-pressure line 52 running between the evaporator 48 and compressor. While a heat exchanger medium present in a predominantly gaseous form flows through the interior 16 of the inner tube 12 in the view sketched on FIG. 1 in a direction of flow 35 leading from an inlet 20 shown on the left to an outlet 22 lying on the right, a largely oppositely directed flow 33 traverses the intermediate space 18 between the inner tube 12 and outer tube 14.

The regulating units 30 provided directly in the intermediate space 18 make it possible to bring about a temperature-dependent change in flow in the intermediate space 18, in particular in the channels 36 provided with regulating units 30, so that the heat transfer capacity of the tubular heat exchanger 10 can be regulated largely automatically and as a function of temperature.

A potentially damaging overheating of the compressor 44 can be countered as a result, and the heat exchanger 10 exhibiting an integrated overheating safeguard can provide itself with an elevated heat transfer capacity so as to optimize the air conditioner circuit.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A heat exchanger for a motor vehicle air conditioning system, the heat exchanger comprising:
an inner tube through which a heat exchanger medium can flow;
an outer tube that at least regionally envelops the inner tube forming an intermediate space; and
a regulating unit fluidically connected to the intermediate space, wherein the regulating unit is configured to alter a flow resistance of the intermediate space as a function of a temperature of the heat exchanger medium that flows through the intermediate space.

2. The heat exchanger according to claim 1, wherein the regulating unit is situated in the intermediate space between the inner tube and the outer tube.

3. The heat exchanger according to claim 1, wherein the regulating unit is secured to an external side of the inner tube or an internal side of the outer tube.

4. The heat exchanger according to claim 1, wherein the regulating unit is configured to reduce a flow cross section of the intermediate space or increase the flow resistance of the intermediate space given a rise in the temperature of the heat exchanger medium.

5. The heat exchanger according to claim 1, wherein the regulating unit comprises a bimetal segment that abuts against the inner tube or the outer tube at the temperature of the heat exchanger medium below a prescribed threshold.

6. The heat exchanger according to claim 5, wherein the bimetal segment extends away from the inner tube or the outer tube in a radial direction at the temperature of the heat exchanger medium above a prescribed threshold so as to reduce a flow-through cross sectional surface of the intermediate space.

7. The heat exchanger according to claim 6, wherein the regulating unit comes to abut against an opposing wall of the inner tube or the outer tube once a closed position has been reached.

8. The heat exchanger according to claim 5, wherein the intermediate space is divided into a plurality of channels in a circumferential direction of the inner tube or the outer tube, wherein the plurality of channels are separated from each other by webs running in an axial or longitudinal direction of the inner tube or the outer tube.

9. The heat exchanger according to claim 8, wherein the regulating unit extends over a circumference and/or a cross sectional surface of more than one channel of the intermediate space.

10. The heat exchanger according to claim 8, wherein each of two channels comprises a regulating unit, and wherein the regulating units exhibit different working points and/or different limit temperatures.

11. The heat exchanger according to claim 5, wherein the bimetal segment is configured such that a lower side of the bimetal segment faces in an opposite direction of the flow of the heat exchanger medium.

12. The heat exchanger according to claim 1, wherein the inner tube is a low-pressure line and the outer tube is a high-pressure line.

13. The heat exchanger according to claim 1, wherein opposing end sections of the inner tube are situated downstream from an evaporator and upstream from a compressor, and wherein opposing end sections of the outer tube are situated upstream from an expansion device and downstream from a capacitor in a refrigerant circuit of the motor vehicle air conditioning system.

14. A motor vehicle air conditioning system with a refrigerant circuit that couples at least a compressor, capacitor, expansion device and evaporator with each other in terms of fluid mechanics in order to circulate a refrigerant, and that comprises a heat exchanger comprising:
an inner tube through which a heat exchanger medium can flow;
an outer tube that at least regionally envelops the inner tube forming an intermediate space; and
a regulating unit fluidically connected to the intermediate space, wherein the regulating unit is configured to alter a flow resistance of the intermediate space as a function of a temperature of the heat exchanger medium that flows through the intermediate space.

15. The motor vehicle air conditioning system according to claim 14, wherein the regulating unit is situated in the intermediate space between the inner tube and the outer tube.

16. The heat exchanger according to claim 14, wherein the regulating unit is configured to reduce a flow cross section of the intermediate space or increase the flow resistance of the intermediate space given a rise in the temperature of the heat exchanger medium.

17. The heat exchanger according to claim 14, wherein the regulating unit comprises a bimetal segment that abuts against the inner tube or the outer tube at the temperature of the heat exchanger medium below a prescribed threshold.

18. The heat exchanger according to claim 17, wherein the bimetal segment extends away from the inner tube or the outer tube in a radial direction at the temperature of the heat exchanger medium above a prescribed threshold so as to reduce a flow-through cross sectional surface of the intermediate space.

19. The heat exchanger according to claim 17, wherein the intermediate space is divided into a plurality of channels in a circumferential direction of the inner tube or the outer tube, wherein the plurality of channels are separated from each other by webs running in an axial or longitudinal direction of the inner tube or the outer tube.

20. A motor vehicle with an air conditioning system having a refrigerant circuit that couples at least a compressor, capacitor, expansion device and evaporator with each other in terms of fluid mechanics in order to circulate a refrigerant, and that comprises a heat exchanger comprising:
an inner tube through which a heat exchanger medium can flow;
an outer tube that at least regionally envelops the inner tube forming an intermediate space; and
a regulating unit fluidically connected to the intermediate space, wherein the regulating unit is configured to alter a flow resistance of the intermediate space as a function of a temperature of the heat exchanger medium that flows through the intermediate space.
